(19) United States
(12) Patent Application Publication
(10) Pub. No.: US 2017/0083933 A1
(43) Pub. Date: Mar. 23, 2017

(54) INFORMATION PROCESSING DEVICE, INFORMATION PROCESSING METHOD, AND NON-TRANSITORY COMPUTER READABLE STORAGE MEDIUM

(71) Applicant: YAHOO JAPAN CORPORATION, Tokyo (JP)

(72) Inventors: Humio SAKURAI, Tokyo (JP); Yasuaki HYODO, Tokyo (JP); Norikazu HIROSE, Tokyo (JP); Shinichiro ODA, Tokyo (JP)

(73) Assignee: YAHOO JAPAN CORPORATION, Tokyo (JP)

(21) Appl. No.: 15/226,530

(22) Filed: Aug. 2, 2016

(30) Foreign Application Priority Data
Sep. 18, 2015 (JP) 2015-185055
Sep. 18, 2015 (JP) 2015-185063
Sep. 18, 2015 (JP) 2015-185067

(51) Int. Cl. G06Q 30/02; G01C 21/36; G06F 17/30; G10L 17/22; H04W 8/24

(52) U.S. Cl. CPC G06Q 30/0242; G10L 17/22; H04W 8/24; G06F 17/30241; G06F 17/30864; G01C 21/3697

(57) ABSTRACT

An information processing device that performs navigation processing for searching a route to a destination and presenting a guide route in accordance with a search result includes an output control module that causes a voice output module to output, by voice, a voice advertisement or a questionnaire related to a voice advertisement based on a conversation with a user during the navigation processing.

### CROSS-REFERENCE TO RELATED APPLICATION(S)

The present application claims priority to and incorporates by reference the entire contents of Japanese Patent Application No. 2015-185055 filed in Japan on Sep. 18, 2015, Japanese Patent Application No. 2015-185063 filed in Japan on Sep. 18, 2015 and Japanese Patent Application No. 2015-185067 filed in Japan on Sep. 18, 2015.

### BACKGROUND OF THE INVENTION

1. Field of the Invention

The present invention relates to an information processing device, an information processing method, and a non-transitory computer readable storage medium.

2. Description of the Related Art

Conventionally developed are information processing devices that implement, in cooperation with a terminal device mounted on a vehicle, a navigation function of searching a route to a destination and presenting a guide route in accordance with a search result. When a user sets a departure point and a destination on a terminal device, the information processing device searches an optimum route from the departure point to the destination using map data, and causes the optimum route to be displayed on a display unit of the terminal device together with a present location mark.

Known is a technique for causing the display unit of the terminal device to display an advertisement.

For example, a technique has been disclosed for causing the user to input user information as a condition for starting to utilize the navigation function, and causing an advertisement based on the user information to be displayed.

A technique has also been disclosed for setting the destination and the like by the terminal device through a conversation with the user.

However, in the related art, there has been a problem in that an opportunity for displaying the advertisement is very limited to a period during which the vehicle is stopping before the destination is set.

The related art is a technique for displaying the advertisement on the display unit of the terminal device, and thus there has been a problem in that when the advertisement is displayed when the vehicle is running, a driver cannot properly and visually recognize the advertisement, so that advertising effectiveness cannot be expected.

When a voice advertisement is provided as in the related art, an amount of information is limited, and a plurality of advertisements cannot be recognized at the same time because a human being can recognize only one thing at a time. Accordingly, for example, it has been actually impossible to choose or examine visiting order for the advertisements considering priority of the advertisements in a safe and appropriate state.

In the related art, although suitable conversation content varies depending on a traveling state such as an environment outside the vehicle and a physical condition of the user, a conversation cannot be controlled in accordance with the traveling state. The user spends a long time in the vehicle and the traveling state varies. Thus, there has been a problem in that, when the conversation cannot be controlled in accordance with the traveling state, an environment in the vehicle comfortable for the user cannot be made.

### SUMMARY OF THE INVENTION

It is an object of the present invention to at least partially solve the problems in the conventional technology.

An information processing device, according to the present application, that performs navigation processing for searching a route to a destination and presenting a guide route in accordance with a search result, the information processing device includes an output control module that causes a voice output module to output, by voice, a voice advertisement or a questionnaire related to a voice advertisement based on a conversation with a user during the navigation processing.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a main control configuration of each device constituting an information processing system according to an embodiment;

FIG. 2 is a flowchart illustrating an example of processing of causing a voice advertisement or a questionnaire related to a voice advertisement to be output by voice in the information processing system according to the embodiment;

FIGS. 3A to 3D are diagrams illustrating an example of a conversation in the processing in FIG. 2;

FIG. 4 is a flowchart illustrating an example of processing of controlling a characteristic of an utterance during a conversation with a user based on a traveling state in the information processing system according to the embodiment;

FIG. 5 is a flowchart illustrating an example of processing of re-outputting the advertisement that has been output by voice when a predetermined condition is satisfied in the information processing system according to the embodiment;

FIGS. 6A and 6B are diagrams illustrating an example of a conversation in the processing in FIG. 5;

FIG. 7 is a diagram illustrating an example of a screen for setting a point related to the advertisement as a via-point; and

FIG. 8 is a diagram illustrating an example of a screen displaying advertisements in superiority order.

### DETAILED DESCRIPTION OF THE PREFERRED EMBODIMENTS

The following describes an embodiment of the present invention in detail with reference to the drawings.

1. Description of Configuration

The following describes an embodiment of the present invention in detail with reference to the drawings.

1-1. Description of System Configuration

First, the following describes a configuration of an information processing system 1 according to the embodiment.

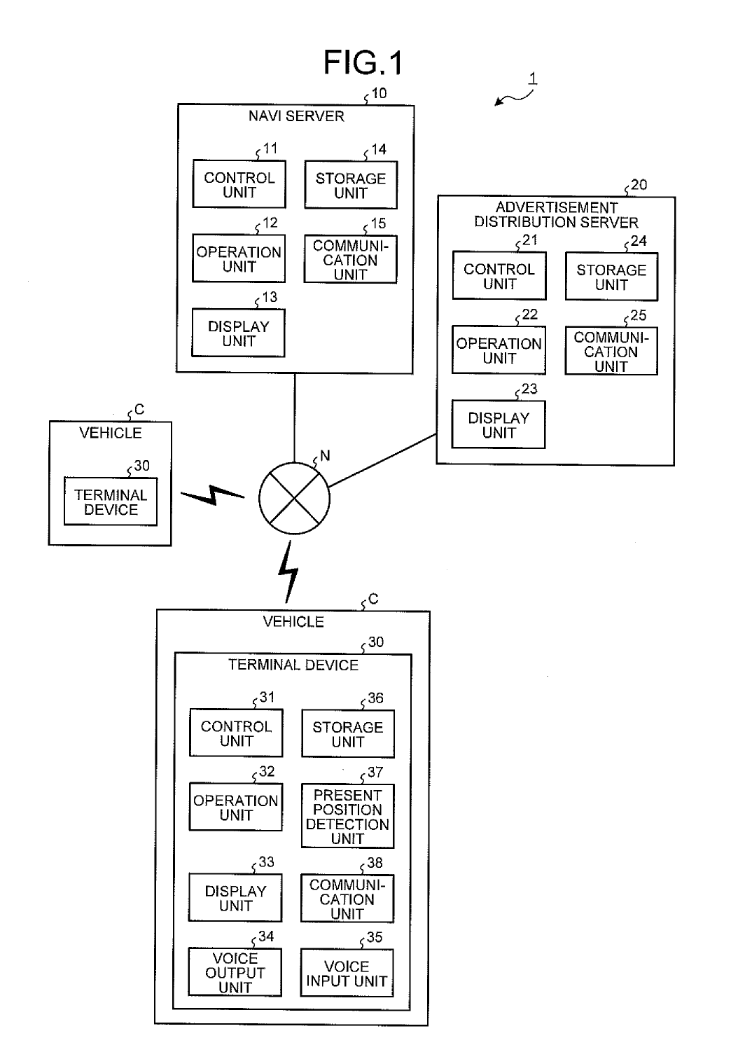

As illustrated in FIG. 1, the information processing system 1 includes a navigation server (hereinafter, referred to as a navi server) 10 and an advertisement distribution server 20 each serving as an information processing device, and a terminal device 30 mounted on a vehicle C. The devices constituting the information processing system 1 are connected to a communication network N. Specifically, the communication network N is the Internet, and a telephone line network and a mobile phone communication network of telecommunications carriers and the like.

The navi server 10 is, for example, an information device such as a PC and a work station (WS) in which probe information transmitted from the terminal device 30 via the communication network N is accumulated. Although the navi server 10 is constituted of one device, the embodiment is not limited thereto. The navi server 10 may be constituted of a plurality of devices.

The advertisement distribution server 20 is, for example, an information device such as a PC and a work station (WS), and distributes content related to an advertisement such as a voice advertisement and other content such as news to the terminal device 30 via the communication network N. Although the advertisement distribution server 20 is constituted of one device, the embodiment is not limited thereto. The advertisement distribution server 20 may be constituted of a plurality of devices.

The terminal device 30 is a portable terminal device carried and used by each user such as a smart device including a smartphone and a tablet, and a mobile phone. On the terminal device 30, installed is an application that implements a car navigation function (hereinafter, referred to as a car navigation application) for searching a route to a destination and presenting a guide route in accordance with a search result. The terminal device 30 communicates with the navi server 10 or the advertisement distribution server 20 using the communication network N (specifically, a communication line for the terminal device 30, a wireless local area network (LAN), and the like).

1-2. Description of Configuration of Navi Server

Next, the following describes a configuration of the navi server 10.

The navi server 10 includes a control unit 11, an operation unit 12, a display unit 13, a storage unit 14, and a communication unit 15.

The control unit 11 centrally controls an operation of the navi server 10. Specifically, the control unit 11 includes a CPU, a ROM, a RAM, and the like, and integrally controls each component of the navi server 10 in cooperation with the ROM loaded into a working area of the RAM, program data stored in the storage unit 14, and the CPU.

The operation unit 12 includes, for example, a keyboard having a character input key, a numeric input key, and other keys associated with various functions, and a pointing device such as a mouse. The operation unit 12 receives an operation input from the user, and outputs an operation signal corresponding to the operation input to the control unit 11.

The display unit 13 includes, for example, a display such as a liquid crystal display (LCD), and displays an image based on a display control signal output from the control unit 11 on a display screen.

The storage unit 14 includes, for example, a hard disk drive (HDD) and a semiconductor memory, and stores data such as program data and various pieces of setting data from the control unit 11 in a readable and writable manner.

The storage unit 14 stores map data, voice data, and the like. For example, in the map data, stored are map information covering a wide area (compatible with a plurality of reduced scales), road information, and various pieces of symbol information such as facilities, the sea, and a river. In the voice data, for example, message data including a word, a phrase, and the like required for route guidance is stored in advance.

The communication unit 15 is a communication interface including an integrated circuit (IC) for communication and a communication connector, and performs data communication via the communication network N using a predetermined communication protocol under control of the control unit 11. For example, the communication unit 15 receives destination information set by a driver, present position information detected by a present position detection unit 37 of the terminal device 30, and probe information generated by a control unit 31 of the terminal device 30. The communication unit 15 transmits a route search result and the like to the terminal device 30 together with the map data and the voice data. The communication unit 15 transmits the received destination information, present position information, probe information, and the like to the advertisement distribution server 20.

1-3. Description of Configuration of Advertisement Distribution Server

Next, the following describes a configuration of the advertisement distribution server 20.

The advertisement distribution server 20 includes a control unit 21, an operation unit 22, a display unit 23, a storage unit 24, and a communication unit 25.

The control unit 21 centrally controls an operation of the advertisement distribution server 20. Specifically, the control unit 21 includes a CPU, a ROM, a RAM, and the like, and integrally controls components of the advertisement distribution server 20 in cooperation with the ROM loaded into the working area of the RAM, program data stored in the storage unit 24, and the CPU.

For example, the control unit 21 selects content such as a voice advertisement and news based on the destination information, the present position information, and the probe information transmitted from the navi server 10, and a response of the user transmitted from the terminal device 30, and transmits the content to the terminal device 30 via the communication unit 25.

The control unit 21 performs voice recognition processing on the response of the user transmitted from the terminal device 30. As the voice recognition processing, a known voice recognition technique is used, and detailed description thereof is not provided.

The operation unit 22 includes, for example, a keyboard having a character input key, a numeric input key, and other keys associated with various functions, and a pointing device such as a mouse. The operation unit 22 receives an operation input from the user, and outputs an operation signal corresponding to the operation input to the control unit 21.

The display unit 23 includes, for example, a display such as an LCD, and displays an image based on a display control signal output from the control unit 21 on the display screen.

The storage unit 24 includes, for example, an HDD and a semiconductor memory, and stores data such as program data and various pieces of setting data from the control unit 21 in a readable and writable manner.

The storage unit 24 stores various pieces of content related to an advertisement such as a voice advertisement and a questionnaire to be distributed to the terminal device 30, and other content such as news. The storage unit 24 associates a response (including an operation) of the user to the advertisement distributed to the terminal device 30 with the advertisement to be stored.

The communication unit 25 is a communication interface including an IC for communication, a communication connector, and the like, and performs data communication via the communication network N using a predetermined communication protocol under control of the control unit 21. For example, the communication unit 25 receives the destination information, the present position information, the probe information, and the like transmitted from the navi server 10 all the time. The communication unit 25 transmits various pieces of content related to the advertisement such as the voice advertisement to the terminal device 30. The communication unit 25 receives the response of the user transmitted from the terminal device 30.

The communication unit 25 may receive various pieces of information transmitted from the navi server 10 at appropriate intervals, not all the time.

1-4. Description of Configuration of Terminal Device

Next, the following describes a configuration of the terminal device 30.

The terminal device 30 includes the control unit 31, an operation unit 32, a display unit 33, a voice output unit 34, a voice input unit 35, a storage unit 36, the present position detection unit 37, and a communication unit 38.

The control unit 31 centrally controls an operation of the terminal device 30. Specifically, the control unit 31 includes a CPU, a ROM, a RAM, and the like, and integrally controls components of the terminal device 30 in cooperation with the ROM loaded into the working area of the RAM, program data stored in the storage unit 36, and the CPU.

The control unit 31 executes the car navigation application stored in the storage unit 36 to implement a car navigation function in cooperation with the navi server 10. Specifically, when the driver starts the car navigation application and sets the destination, the control unit 31 transmits the destination information and the present position information detected by the present position detection unit 37 to the navi server 10 via the communication unit 38. The control unit 11 of the navi server 10 then performs route searching processing based on the destination information and the present position information transmitted from the terminal device 30, and transmits the route search result to the terminal device 30 via the communication unit 15 together with the map data and the voice data. The control unit 31 of the terminal device 30 causes the route search result to be displayed on the display unit 33 and to be output by voice from the voice output unit 34. In this way, the car navigation function is implemented.

The control unit 31 generates the probe information as needed based on traveling information such as a position where the vehicle C actually travels and a vehicle speed. The control unit 31 then transmits the generated probe information to the navi server 10 as needed via the communication unit 38.

The operation unit 32 includes, for example, a key input unit including a home button and the like and a touch panel integrally formed with the display unit 33. The operation unit 32 receives the operation input from the driver, and outputs an operation signal corresponding to the operation input to the control unit 31.

The display unit (display module) 33 includes, for example, a display such as an LCD or a flat panel display (FPD) including an organic electro luminescence (EL) element, and displays an image based on the display control signal output from the control unit 31 on the display screen. For example, the display unit 33 displays various pieces of information (for example, a map screen, an icon, display information for navigation such as route guidance, and an own vehicle mark indicating a present position of an own vehicle) based on data for display (such as map data) output from the control unit 31.

The voice output unit (voice output module) 34 includes a D/A converter, an amplifier, a speaker, and the like, and converts the voice data output from the control unit 31 into an analog voice signal to be output by voice.

The voice input unit (voice input module) 35 includes a microphone, an A/D converter, and the like, receives a voice input via the microphone, and converts the analog voice signal into digital data to acquire voice data. The voice uttered by the user is input to the voice input unit 35.

The storage unit 36 includes, for example, an HDD and a semiconductor memory, and stores data such as program data and various pieces of setting data from the control unit 31 in a readable and writable manner.

The present position detection unit 37 includes a GPS module, an autonomous navigation unit, and the like. The GPS module includes a GPS antenna and the like. The GPS antenna receives GPS signals transmitted from a plurality of GPS satellites launched into a low earth orbit. The GPS antenna receives the GPS signals transmitted from at least three GPS satellites, detects an absolute present position (latitude and longitude) of the vehicle C based on the received GPS signals, and outputs the absolute present position to the control unit 31.

The autonomous navigation unit includes an angle sensor, a distance sensor, and the like. The angle sensor detects an angular speed of the vehicle (a rotation angle in a horizontal direction per unit time), and calculates a change amount of a moving direction. The distance sensor detects a pulse signal output in accordance with rotation of a wheel, and calculates a movement amount of the vehicle C. The autonomous navigation unit calculates a relative position change of the vehicle C based on an angular speed signal and a vehicle speed pulse signal, and outputs the relative position change to the control unit 31.

The communication unit 38 includes an antenna and a communication circuit, and performs wireless communication between itself and an external apparatus under control of the control unit 31. Specifically, the communication unit 38 performs data communication via the communication network N by being relayed by a base station. For example, the communication unit 38 transmits the destination information set by the driver, the present position information detected by the present position detection unit 37, and the probe information generated by the control unit 31. The communication unit 38 also receives the route search result, the map data, the voice data, and the like transmitted from the communication unit 15 of the navi server 10. The communication unit 38 further receives various pieces of content related to the advertisement such as the voice advertisement transmitted from the advertisement distribution server 20. The communication unit 38 transmits, to the advertisement distribution server 20, the response of the user to the voice advertisement output by voice from the voice output unit 34 and to a questionnaire and the like related to a voice advertisement.

2. Description of Operation

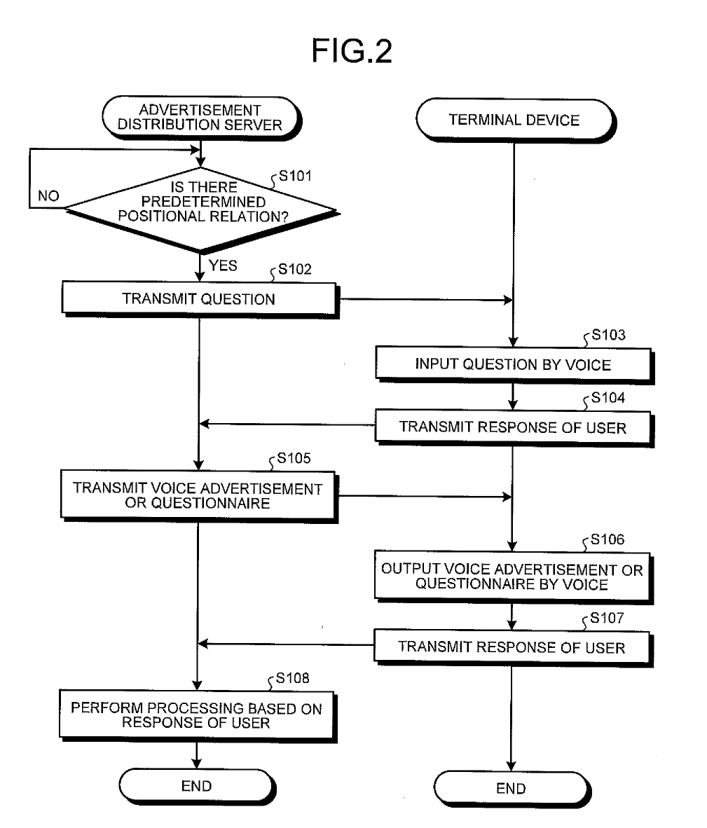

The following describes a specific operation of the information processing system 1 according to the embodiment with reference to FIGS. 2 to 8.

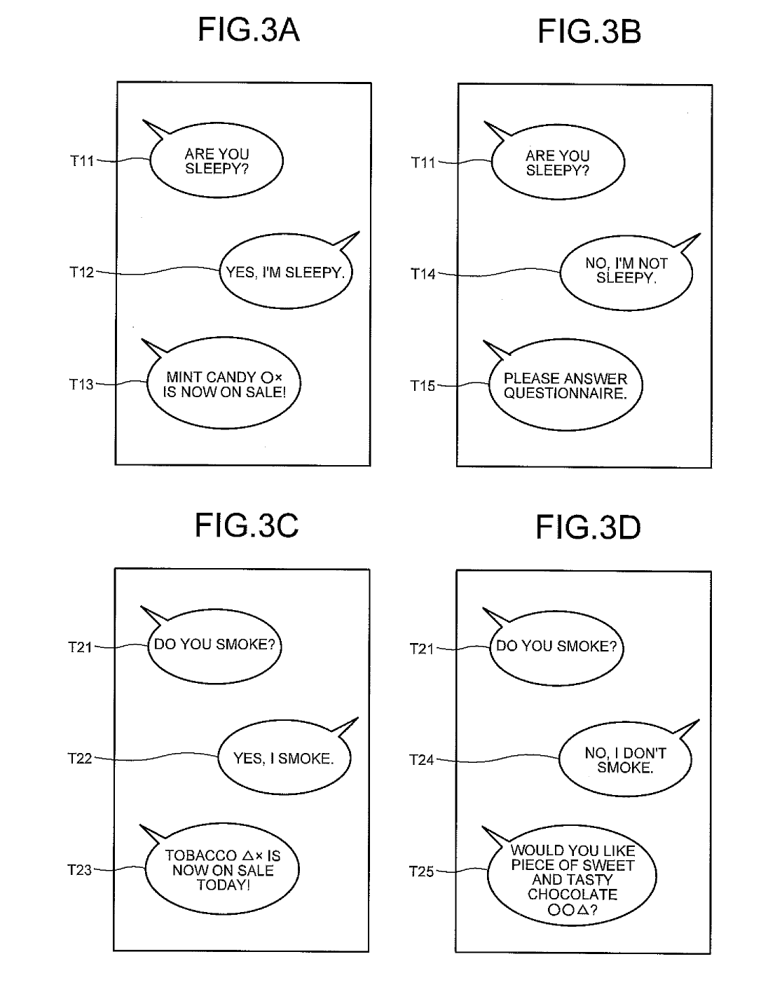

First, the following describes processing, performed by the control unit 21 of the advertisement distribution server 20, of causing the voice output unit 34 of the terminal device 30 to output the voice advertisement or the questionnaire related to a voice advertisement by voice based on a conversation with the user with reference to a flowchart in FIG. 2 and a conversation example in FIG. 3. In this case, the control unit 21 functions as an output control module according to the present embodiment. In the present embodiment, the voice advertisement includes a coupon by which a target commodity can be discounted.

First, as illustrated in FIG. 2, the control unit 21 of the advertisement distribution server 20 refers to the probe information and the setting information related to a traveling route of the user (information about a destination or a via-point) transmitted from the navi server 10, and determines whether there is a predetermined positional relation with respect to a point related to the voice advertisement (Step S101).

If the control unit 21 determines that there is the predetermined positional relation (YES at Step S101), the process proceeds to Step S102.

If the control unit 21 determines that there is no predetermined positional relation (NO at Step S101), the process is repeated until it is determined that there is the predetermined positional relation.

In this case, an example of the predetermined positional relation is a case in which the point is within a predetermined distance from the present location, the destination, and a route connecting the present location and the destination. That is, when the point related to the voice advertisement is present within a predetermined distance from the present location, the destination, and the route connecting the present location and the destination, the control unit 21 determines that there is the predetermined positional relation.

Another example of the predetermined positional relation is a case in which the point is within a predetermined distance from a usual traveling area of the user. That is, when the point related to the voice advertisement is present within a predetermined distance from the usual traveling area of the user, the control unit 21 determines that there is the predetermined positional relation.

Yet another example of the predetermined positional relation is a case in which the point is within a predetermined distance from a place (such as a point and a road) where the user usually passes by. That is, when the point related to the voice advertisement is present within a predetermined distance from the place where the user usually passes by, the control unit 21 determines that there is the predetermined positional relation.

Next, the control unit 21 of the advertisement distribution server 20 transmits a question for confirming a condition for causing the voice advertisement to be output by voice with the user to the terminal device 30 via the communication unit 25 (Step S102). The question for confirming the condition is, for example, a question for confirming attribute information of the user. Examples of the question include “Do you smoke? (T21 in FIG. 3C and FIG. 3D) for confirming whether the user is a smoker, and “Do you like Chinese food?” for determining the user's taste for food.

Another example of the question for confirming the condition is a question for confirming a condition related to vehicle traveling (traveling state). Examples of the condition related to vehicle traveling include “environment outside the vehicle” such as a day of the week, a time zone, weather, occurrence of a traffic jam, and a road surface state, “state of the vehicle” such as a speed, a type of the road on which the vehicle is traveling, a residual quantity of gasoline, and a residual quantity of a power rechargeable battery of an electric vehicle, “the destination and the via-point”, “a physical condition of the user” such as sleepiness, hunger, fatigue, and influence of drugs, and “a state of a fellow passenger” such as presence of the fellow passenger, the number, distinction of sex, age, and a body weight thereof. Examples of the question for confirming the condition related to vehicle traveling include “Are you sleepy? (T11 in FIGS. 3A and 3B) for confirming the physical condition of the user, and Is the traffic congested?” for confirming the environment outside the vehicle.

The control unit 31 of the terminal device 30 causes the question transmitted from the advertisement distribution server 20 to be output by voice via the voice output unit 34 (Step S103).

The control unit 31 of the terminal device 30 then acquires the response of the user to the question via the voice input unit 35, and transmits the response to the advertisement distribution server 20 via the communication unit 38 (Step S104). Examples of the response of the user include a response such as “Yes, I'm sleepy (T12 in FIG. 3A)”, “No, I'm not sleepy (T14 in FIG. 3B)”, “Yes, I smoke (T22 in FIG. 3C)”, “No, I don't smoke (T24 in FIG. 3D)”, and no response.

The control unit 21 of the advertisement distribution server 20 controls a voice output based on the response of the user transmitted from the terminal device 30 (Step S105). For example, the control unit 21 transmits the voice advertisement or the questionnaire related to a voice advertisement to the terminal device 30 via the communication unit 38. When the control unit 21 determines not to perform the voice output as a result of voice recognition on the response of the user, the process is ended as it is.

The control unit 31 of the terminal device 30 outputs the voice advertisement or the questionnaire related to a voice advertisement transmitted from the advertisement distribution server 20 by voice via the voice output unit (Step S106). For example, “Mint candy Ox is now on sale! (T13 in FIG. 3A)” is output by voice when the user says that he/she is sleepy (T12 in FIG. 3A), “Please answer the questionnaire (T15 in FIG. 3B)” is output by voice when the user does not say he/she is sleepy (T14 in FIG. 3B), “Tobacco Δx is now on sale today! (T23 in FIG. 3C)” is output by voice when the user is a smoker (T22 in FIG. 3C), and “Would you like a piece of sweet and tasty chocolate OOΔ? (T25 in FIG. 3D)” is output by voice when the user is not a smoker (T24 in FIG. 3D).

Next, the control unit 31 of the terminal device 30 acquires the response of the user to the voice output (the voice advertisement or the questionnaire) via the voice input unit 35, and transmits the response to the advertisement distribution server 20 via the communication unit 38 (Step S107). Examples of the response of the user include “information indicating an effect of the voice advertisement”, “information indicating an action based on the voice advertisement”, an answer to the questionnaire, and no response. Examples of the information indicating the effect of the voice advertisement include an answer such as “Yes (affirmation)” or “No (negation)” to “Are you interested in the advertisement?” that follows the voice advertisement. Examples of the information indicating the action based on the voice advertisement include information indicating an action of registering a store as the destination or the via-point, an action of temporarily bookmarking a commodity page to be displayed when the vehicle stops, and an action of performing predetermined registration so that the commodity page is automatically displayed when the user logs in a PC site using the same ID as a user ID for the car navigation application.

Next, the control unit 21 of the advertisement distribution server 20 performs processing based on the response of the user transmitted from the terminal device 30 (Step S108).

For example, when the acquired response of the user is the answer to the questionnaire, the control unit 21 transmits privilege information for giving a privilege (for example, a privilege point) to the terminal device 30 via the communication unit 25 as processing based on the response.

The control unit 31 of the terminal device 30 outputs the information transmitted from the advertisement distribution server by voice via the voice output unit 34. For example, the control unit 31 outputs “The answer to the questionnaire is received. A privilege point is given.” by voice.

When the acquired response of the user is the information indicating the effect of the voice advertisement or the information indicating the action based on the voice advertisement, the control unit 21 of the advertisement distribution server 20 analyzes these pieces of information and measures the effect of the voice advertisement as processing based on the response. That is, the control unit 21 functions as an effect measuring module according to the present embodiment. For example, when the response is the information indicating the effect of the voice advertisement, the control unit 21 analyzes answer content (a degree of affirmation and negation), and measures the effect. When the response is the information indicating the action based on the voice advertisement, the control unit 21 regards the response as an affirmative reaction, and measures the effect. When there is no response, the control unit 21 regards it as a negative reaction, and measures the effect.

In voice recognition, the control unit 21 of the advertisement distribution server 20 acquires a user's evaluation (degree of affirmation and negation) of the voice advertisement output before the response as a response element based on a characteristic of the utterance in the response of the user, and reflects the response element in the effect of the voice advertisement. Examples of the characteristic of the utterance include an utterance speed and a waiting time until the utterance is started.

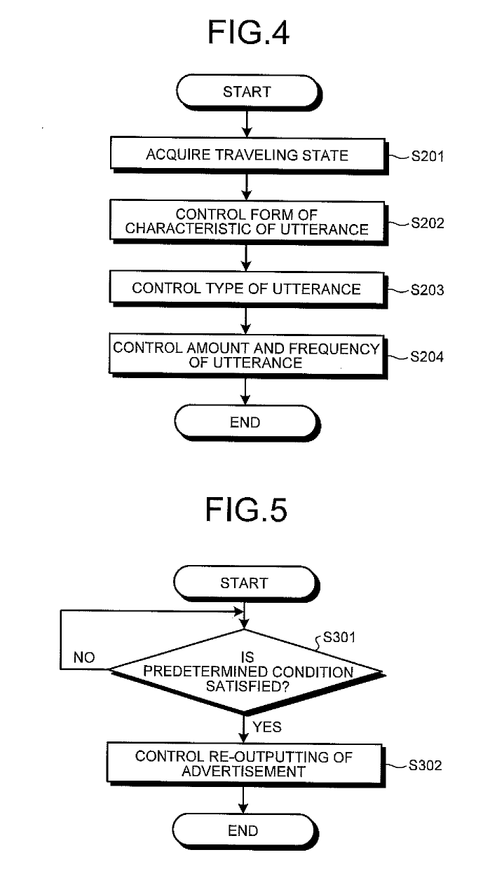

Next, the following describes processing of controlling the characteristic of the utterance in the voice output from the voice output unit 34 of the terminal device 30 based on a traveling state of the vehicle C on which the user is riding with reference to a flowchart in FIG. 4. In this case, the control unit 21 functions as an utterance control module according to the present embodiment. This processing is performed on all pieces of content (including navigation information and the like) output from the terminal device 30 by voice, not only on the voice advertisement and the questionnaire related to a voice advertisement.

First, as illustrated in FIG. 4, the control unit 21 of the advertisement distribution server 20 refers to the probe information transmitted from the navi server 10 and the setting information related to the traveling route of the user (information about the destination and the via-point), and acquires the traveling state of the vehicle C on which the user is riding (Step S201). The control unit 21 controls the characteristic of the utterance based on the acquired traveling state.

In this case, an example of the traveling state is the environment outside the vehicle. Examples of the environment outside the vehicle include a day of the week, a time zone, weather, occurrence of a traffic jam, and a road surface state. The control unit 21 controls the utterance to be a casual voice tone (voice or a way of talking) on a holiday, to be a cheerful voice tone on a rainy day, and to be a settled voice tone at night.

Another example of the traveling state is a state of the vehicle. Examples of the state of the vehicle include a speed, a type of the road on which the vehicle is traveling, a residual quantity of gasoline, and a residual quantity of a power rechargeable battery of an electric vehicle. For example, the control unit 21 controls the utterance to be a settled voice tone when the vehicle is traveling slowly, and to be a cheerful voice tone when the vehicle is traveling on a road along the sea.

For example, “content” of the utterance may be controlled in accordance with the state of the vehicle. For example, an utterance may be given for attracting attention to a distance from a car in front when the vehicle is traveling on an expressway, and an utterance may be given for urging the driver to stop at the next service area when the residual quantity of gasoline is reduced. Alternatively, when the residual quantity of gasoline is reduced, news or trivia related to gasoline may be read aloud.

Other examples of the traveling state include the destination and the via-point. For example, when Disneyland is set as the destination, the control unit 21 controls the utterance to be a voice of Mickey Mouse.

Another example of the traveling state is the physical condition of the user. Examples of the physical condition of the user include sleepiness, hunger, fatigue, and influence of drugs. For example, when the user is sleepy or fatigued, the control unit 21 performs control for slowing down the utterance speed, or increasing a conversation amount to shake off the sleepiness. Alternatively, when the user is sleepy, a questionnaire including a brain-teasing question may be output by voice in addition to simple confirmation of a fact.

The physical condition of the user may be determined based on the characteristic of the utterance in the response instead of directly asking the user. Examples of the characteristic of the utterance include an utterance speed and a waiting time until the utterance is started. For example, when the utterance speed is slow or the waiting time until the utterance is started is long, it is determined that the user is “sleepy” or “fatigued”. In this case, in determining the physical condition of the user, other information such as “at night” or “after dinner” may be added.

Another example of the traveling state is a state of the fellow passenger. Examples of the state of the fellow passenger include presence of the fellow passenger, the number, distinction of sex, age, and a body weight thereof. For example, when the body weight of the fellow passenger is very small, the control unit 21 determines that the fellow passenger is a child, and controls the utterance to be a voice of a character popular with children. When the fellow passenger is a child, a voice for urging a bathroom break may be output.

The state of the fellow passenger may be determined based on a characteristic of a voice of the fellow passenger instead of directly asking the user. The characteristic of the voice of the fellow passenger is, for example, a frequency band of the voice of the fellow passenger. By acquiring the voice of the fellow passenger via the voice input unit 35 of the terminal device 30 and analyzing the frequency band of the voice of the fellow passenger, presence of the fellow passenger, the number, distinction of sex, age, and the like thereof can be determined.

The control unit 21 of the advertisement distribution server 20 may perform control for changing the voice output from the voice output unit 34 of the terminal device 30 into a voice different from a standard (default) voice. That is, the control unit 21 functions as a voice changing module according to the present embodiment.

When the voice is changed into a different voice and the fellow passenger is detected, the control unit 21 may perform control for changing the voice into the standard voice.

The control unit 21 of the advertisement distribution server 20 then controls a form of the characteristic of the utterance based on the traveling state acquired at Step S201 (Step S202). The form of the characteristic of the utterance is, for example, a speaking speed, a tone of the voice, an utterance expression, and a vocabulary. For example, when fellow passengers include many children, the control unit 21 controls the utterance to be an expression that can be understood by a child.

Next, the control unit 21 of the advertisement distribution server 20 controls a type of the utterance based on the traveling state acquired at Step S201 (Step S203). Examples of the type of the utterance include the questionnaire, the voice advertisement, and other content (such as news). For example, when the vehicle is traveling on an expressway, a restaurant and the like are not present around the vehicle, and the effect caused by the voice advertisement is not expected so much, so that news in which the user may be interested may be read aloud. When the user does not want news, the questionnaire may be provided. When the vehicle is traveling on an ordinary road, the voice advertisement may be provided.

Next, the control unit 21 of the advertisement distribution server 20 controls an amount of utterance and frequency of utterance based on the traveling state acquired at Step S201 (Step S204). For example, the user is free during a traffic jam, and tends to be sleepy at night, so that a demand of the user for conversation is caused. Thus, for example, the control unit 21 performs control for relatively increasing the amount or frequency of utterance during a traffic jam or at night.

The processes at Steps S202 to S204 may be performed in random order.

In addition to control of the characteristic of the utterance based on the traveling state, a question may be uttered, and content of the utterance may be controlled based on the response of the user to the question.

For example, when a response of “I'm not sleepy” is acquired for a question of “Are you sleepy?”, thinking power of the user can be expected, so that the questionnaire may be provided to the user. When a response of “I'm sleepy” is acquired, an advertisement of a mint candy or news effective for shaking off sleepiness may be provided. When a response of “I smoke” is acquired for a question of “Do you smoke?”, the user seems to be interested in tobacco, so that an advertisement of tobacco may be provided.

In addition to control of the characteristic of the utterance based on the traveling state, a question may be uttered, and the type of the utterance may be controlled based on the response of the user to the question.

For example, when a response of “I'm not sleepy” is acquired for a question of “Are you sleepy?”, thinking power of the user can be expected, so that the questionnaire is provided to the user. When the questionnaire is finished, content such as news is provided. When a response of “I'm sleepy” is acquired, an advertisement of a mint candy effective for shaking off sleepiness is provided. When a response of “I smoke” is acquired for a question of “Do you smoke?”, the user seems to be interested in tobacco, so that an advertisement of tobacco is provided.

In controlling the characteristic of the utterance based on the traveling state, when the vehicle C is stopping, an image related to the utterance may be displayed on the display unit 33 of the terminal device 30 during the utterance. Examples of the image related to the utterance include a page or an image related to the content of the utterance such as a related wiki page and a commodity page for explaining specific content of a commodity.

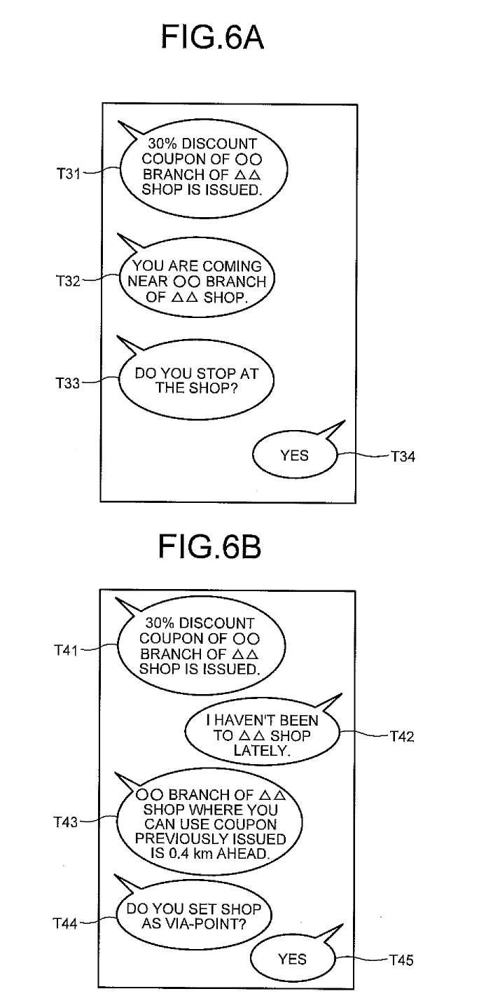

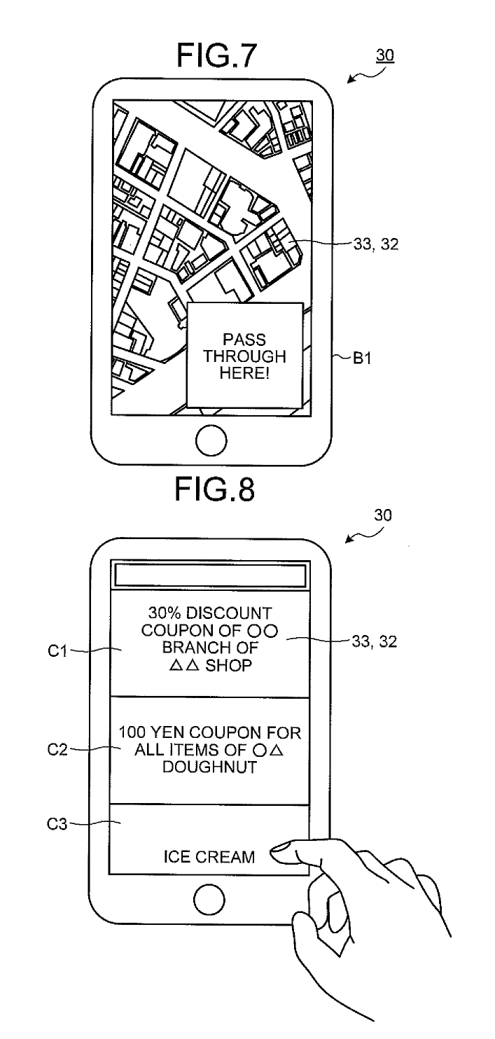

The following describes processing of re-outputting the advertisement output by voice from the voice output unit 34 (output module) of the terminal device 30 when a predetermined condition is satisfied with reference to a flowchart in FIG. 5, a conversation example in FIG. 6, and screen examples in FIGS. 7 and 8. In this case, re-outputting is not limited to the second voice output, and includes an image output and the like of the content output by voice. Re-outputting is not limited to a case of outputting completely the same content as the content output by voice, and includes a case of outputting similar or related content. That is, processing of re-outputting means processing of causing at least of the second voice output and the image output to be performed. In this processing, a coupon by which a target commodity can be discounted is exemplified as the advertisement that has been previously output by voice.

First, as illustrated in FIG. 5, the control unit 21 of the advertisement distribution server 20 refers to the probe information transmitted from the navi server 10 and the setting information related to the traveling route of the user (information about the destination and the via-point), and determines whether the predetermined condition is satisfied (Step S301).

If it is determined that the predetermined condition is satisfied (YES at Step S301), the control unit 21 controls re-outputting of the advertisement (coupon) (Step S302).

If it is determined that the predetermined condition is not satisfied (NO at Step S301), the control unit 21 repeats the process until it is determined that the predetermined condition is satisfied.

An example of the predetermined condition is that there is a predetermined positional relation with respect to a point related to the advertisement. That is, the control unit 21 determines that the predetermined condition is satisfied when there is the predetermined positional relation with respect to the point related to the advertisement, and controls re-outputting of the advertisement.

An example of the predetermined positional relation is that the present location is within a predetermined distance from the point related to the advertisement. For example, the control unit 21 determines that there is the predetermined positional relation when the present location is within 500 m from the point related to the advertisement.

Another example of the predetermined positional relation is that the point related to the advertisement is on a route to be taken by the user. That is, the control unit 21 determines that there is the predetermined positional relation when the point related to the advertisement is present on the route to be taken by the user.

Another example of the predetermined positional relation is that the point related to the advertisement is within a predetermined distance from the route to be taken by the user. For example, the control unit 21 determines that there is the predetermined positional relation when the point related to the advertisement is within 100 m from the route to be taken by the user.

Another example of the predetermined positional relation is that the point related to the advertisement is within a spindle-shaped range connecting the present location with the destination. For example, the control unit 21 determines that there is the predetermined positional relation when the point related to the advertisement is within a spindle-shaped (for example, a maximum width is equal to or smaller than 300 m) range connecting the present location with the destination.

FIG. 6A illustrates a conversation example in a case in which the present location is within a predetermined distance (within 500 m) from the point related to the advertisement. FIG. 6A illustrates a conversation example in a case in which a coupon of “OO branch of ΔΔ shop”, which is a beef bowl shop, has been previously output by voice.

In outputting the coupon of “OO branch of ΔΔ shop” by voice, the control unit 31 of the terminal device 30 outputs, for example, “30% discount coupon of OO branch of ΔΔ shop is issued (T31)” by voice.

Thereafter, if it is determined that the present location is within 500 m from the point related to the advertisement (“OO branch of ΔΔ shop”), the control unit 31 outputs, for example, “You are coming near OO branch of ΔΔ shop (T32)” and “Do you stop at the shop? (T33)” by voice to re-output the coupon of “OO branch of ΔΔ shop”.

When acquiring an affirmative response of the user such as “Yes (T34)” via the voice input unit 35, for example, the control unit 31 sets “OO branch of ΔΔ shop” as the via-point.

In the example illustrated in FIG. 6A, when it is determined that the present location is within 500 m from the point related to the advertisement (“OO branch of ΔΔ shop”), instead of outputting “You are coming near OO branch of ΔΔ shop (T32)” by voice to attract attention of the user and outputting “Do you stop at the shop? (T33)” by voice, a big “pass through here” button B1 may be displayed on the display unit 33 (output module) as illustrated in FIG. 7.

In this case, when the user presses the “pass through here” button B1, the control unit 31 sets “OO branch of ΔΔ shop” as the via-point.

Another example of the predetermined condition is that a predetermined keyword (word) related to the advertisement uttered by the user is acquired within a predetermined range (for example, within 500 m) from the point related to the advertisement. Examples of the predetermined keyword related to the advertisement include a shop name and a trade name.

Similarly to FIG. 6A, FIG. 6B is an conversation example in a case in which the coupon of “OO branch of AA shop”, which is a beef bowl shop, has been previously output by voice.

In outputting the coupon of “OO branch of ΔΔ shop” by voice, the control unit 31 of the terminal device 30 outputs, for example, “30% discount coupon of OO branch of ΔΔ shop is issued (T41)” by voice.

Thereafter, when the present location is within 500 m from the point related to the advertisement (“OO branch of ΔΔ shop”), and the utterance including a predetermined word related to the advertisement (for example, ΔΔ shop) uttered by the user is acquired (for example, “I haven't been to ΔΔ shop lately (T42)”), the control unit 31 outputs “OO branch of ΔΔ shop where you can use the coupon previously issued is 0.4 km ahead (T43)” and “Do you set the shop as the via-point? (T44)” by voice to re-output the coupon of “OO branch of ΔΔ shop”.

When acquiring an affirmative response of the user such as “Yes (T45)” via the voice input unit 35, for example, the control unit 31 sets “OO branch of ΔΔ shop” as the via-point.

For example, when the vehicle is stopping, the coupon may be automatically displayed on the display unit 33 of the terminal device 30. Alternatively, a menu operation may be enabled by interrupting a guidance function of a car navigation system when the vehicle is stopping, and a function of displaying the coupon may be enabled to be manually selected from a menu screen.

Another example of the predetermined condition is that the vehicle is stopping. That is, the control unit 21 determines that the predetermined condition is satisfied when the vehicle C is stopping, and controls re-outputting of the advertisement.

For example, when the vehicle C is stopping, the control unit 21 lists and displays, on the display unit 33 of the terminal device 30, coupons issued while the vehicle C is traveling. In this case, for example, when the user touches one of the coupons listed and displayed on the display unit 33, a screen for explaining a specific use condition (such as an expiration date) of the coupon may be displayed, or a screen including a bar code to be seen by a salesperson may be displayed.

Another example of the predetermined condition is that a second terminal device 30 associated with the terminal device 30 (referred to as a first terminal device 30 in this example) is present in the vehicle C. The terminal devices 30 associated with each other can remotely perform operation of searching a shop, additional setting of the via-point, and the like. The terminal devices 30 are associated with each other, for example, by designating, when the terminal devices 30 have logged in a navigation service using respective user IDs, the user ID of the second terminal device 30 from the first terminal device 30, or performing an arranged predetermined operation between the terminal devices 30 via a server device (for example, the navi server 10, the advertisement distribution server 20, and other server devices) or via short-range wireless communication. When the first terminal device 30 of the driver is associated with the second terminal device 30 held by a family member who is a fellow passenger, the control unit 21 determines that the predetermined condition is satisfied, and controls re-outputting of the advertisement.

For example, when there is the second terminal device 30 associated with the first terminal device 30 in the vehicle C, the control unit 21 causes the coupons issued while the vehicle C is traveling to be listed and displayed on the display unit 33 of the second terminal device 30.

Accordingly, even when the vehicle C is traveling, the coupons issued to the first terminal device 30 of the driver can be listed and displayed on the display screen of the terminal device 30 of the fellow passenger.

When remote control is performed through the second terminal device 30 held by the fellow passenger, communication may be made via the navi server 10 or the advertisement distribution server 20, or the terminal devices 30 may directly communicate with each other.

The control unit 21 of the advertisement distribution server 20 may evaluate superiority or inferiority (for example, a degree of affirmation and negation) of the advertisement based on the response of the user to the advertisement output by voice, and may cause the display unit 33 to display the advertisement in superiority order based on the evaluated superiority or inferiority. That is, the control unit 21 functions as a module for evaluating superiority or inferiority according to the present embodiment. For example, when the superiority order is “30% discount coupon C1 of OO branch of ΔΔ shop”, “100 yen coupon C2 for all items of OΔ doughnut”, and “discount coupon C3 for ice cream”, as illustrated in FIG. 8, “30% discount coupon C1 of OO branch of ΔΔ shop”, “100 yen coupon C2 for all items of OΔ doughnut”, and “discount coupon C3 for ice cream” are displayed in this order from the top. The superiority or inferiority for each advertisement is determined based on a degree of interest of the user. The degree of interest of the user is determined based on the utterance of the user. For example, the utterance of the user is an affirmative expression such as “Sounds good” and “It seems interesting”, higher priority is given and display order of the advertisement is set to be higher. When the utterance of the user is a negative expression such as “It's not interesting” or “I don't want it”, lower priority is given and the display order of the advertisement is set to be lower.

The response of the user (including not only the utterance but also an operation) to the output (or re-output) advertisement may be reflected in at least one of the advertisement, an attribute of the advertisement, the user, or an attribute of the user. In this case, “reflect” means that each of the advertisement, the attribute of the advertisement, the user, and the attribute of the user is associated with the evaluation derived from the response of the user to be a guideline for appropriate advertisement distribution in the future.

For example, when a male user A in his thirties affirmatively reacts to the coupon of “OO branch of ΔΔ shop”, which is a beef bowl shop, an affirmative evaluation may be reflected in the “coupon of OO branch of ΔΔ shop” as the advertisement, or the affirmative evaluation may be reflected in a “coupon for a beef bowl” or a “coupon for eating out (a restaurant)” as the attribute of the advertisement. A fact that the “male user A” as the user makes an affirmative evaluation for the coupon of OO branch of ΔΔ shop may be reflected, or the fact that a “male in his thirties” as the attribute of the user makes an affirmative evaluation for the coupon of OO branch of ΔΔ shop may be reflected.

When many users react to the coupon for a beef bowl and few users react to a coupon for fruit, the affirmative evaluation may be reflected in the “coupon for a beef bowl” and a negative evaluation may be reflected in the “coupon for fruit”.

An action tendency of the user may be reflected in the user. For example, when the user A often reacts to a restaurant coupon, the user A may be evaluated as a user who likes the restaurant coupon. When the user A reacts to the whole coupons, the user A may be evaluated as a user who easily reacts to coupons.

Among attributes of the user, the action tendency depending on the sex may be reflected in each sex. For example, when males often touch the coupon for a beef bowl, a fact may be reflected that a male tends to make an affirmative evaluation for the coupon for a beef bowl, and a female does not easily make an affirmative evaluation for the coupon for a beef bowl. When males respond to the coupon in general, and females do not respond to the coupon in general, a fact may be reflected that a male tends to react to the coupon, and a female does not easily react to the coupon.

The response of the user (including not only the utterance but also the operation) to the output (or re-output) advertisement may be reflected in the traveling state.

For example, when many users react to a coupon A when it rains, a fact may be reflected that the user easily reacts to the coupon A on a rainy day.

When many users react to a coupon B when a traveling speed of the vehicle C is relatively high, a fact may be reflected that the user easily reacts to the coupon B when the traveling speed is high.

When many users determined to be sleepy react to a coupon C, a fact may be reflected that the user easily reacts to the coupon C when he/she is sleepy.

The response of the user (including not only the utterance but also the operation) to the output (or re-output) advertisement may be reflected in the characteristic of the utterance in the response of the user.

For example, in a case in which the user reacts strongly when a loud and speedy speech is made about a discount coupon of a shop famous for discounting, and the user reacts weakly when a slow and gentle speech is made, a fact may be reflected that the user tends to react to the discount coupon when a speedy speech is made, and the user does not easily react to the discount coupon when a slow speech is made.

3. Effect

As described above, the information processing device according to the embodiment (the navi server 10 and the advertisement distribution server 20) includes the output control module (control unit 21) that causes the voice output module (voice output unit 34) to output the voice advertisement or the questionnaire related to a voice advertisement by voice based on the conversation with the user during navigation processing.

Accordingly, with the information processing device according to the embodiment, the driver can acquire advertisement information without visually recognizing the display unit 33 of the terminal device 30, so that an effect of the advertisement can be safely and smoothly secured without affecting driving.

With the information processing device according to the embodiment, when there is a predetermined positional relation with respect to the point related to the voice advertisement, the output control module causes the voice output module to output the voice advertisement by voice.

Accordingly, with the information processing device according to the embodiment, the voice advertisement is output when there is a positional relation in which the user tends to be interested, so that advertising effectiveness can be further improved.

With the information processing device according to the embodiment, the output control module causes the voice output module to output, by voice, a question to the user for confirming the condition for outputting the voice advertisement by voice, and controls the voice output of the voice advertisement based on the response of the user to the question acquired via the voice input module (voice input unit 35).

Accordingly, with the information processing device according to the embodiment, information about the user can be acquired through the conversation with the user, so that an effective advertisement output can be implemented without waste.

Regarding the information processing device according to the embodiment, the condition includes a condition related to the traveling state of the vehicle C on which the user is riding.

Accordingly, with the information processing device according to the embodiment, an appropriate advertisement can be selected depending on the traveling state, so that a more effective advertisement output can be implemented.

The information processing device according to the embodiment also includes the effect measuring module (control unit 21) that measures the effect of the voice advertisement based on the response of the user to the voice advertisement acquired via the voice input module.

Accordingly, with the information processing device according to the embodiment, the effect of the output voice advertisement can be acquired, so that the effect can be utilized for providing information to an advertiser or charging advertisement rates.

With the information processing device according to the embodiment, the effect measuring module acquires user's evaluation for the voice advertisement based on the characteristic of the utterance in the response of the user to the voice advertisement, and measures the effect of the voice advertisement.

Accordingly, with the information processing device according to the embodiment, the effect of the output voice advertisement can be acquired with high accuracy, so that more precise information can be provided to the advertiser.

With the information processing device according to the embodiment, the output control module distributes information for conversation to a terminal device mounted on the vehicle on which the user is riding, the information for conversation associating utterance information for performing utterance based on the response of the user with processing information for performing processing based on the response of the user acquired via the voice input module.

Regarding the information processing device according to the embodiment, the information for conversation includes pattern data for collation for performing voice recognition on the response of the user.

Regarding the information processing device according to the embodiment, the utterance includes the questionnaire, the response of the user includes the answer to the questionnaire, and the processing includes output processing of the privilege information.

Regarding the information processing device according to the embodiment, the utterance includes the voice advertisement, the response of the user includes the information indicating the effect of the voice advertisement, and the processing includes processing of transmitting the information indicating the effect of the voice advertisement to the information processing device.

Regarding the information processing device according to the embodiment, the response of the user includes the information indicating the action based on the voice advertisement, and the processing includes processing of transmitting the information indicating the action to the information processing device.

Regarding the information processing device according to the embodiment, the utterance includes the question related to a voice advertisement, the response of the user includes the answer to the question or no response, and the processing includes processing of determining to output one voice advertisement or any one of two or more voice advertisements, or not to output the voice advertisement, based on the answer to the question or no response.

The information processing method performed by the information processing device according to the embodiment includes a step of outputting the voice advertisement or the questionnaire related to a voice advertisement by voice with the voice output module based on the conversation with the user during navigation processing.

The computer program stored in the non-transitory computer readable storage medium according to the embodiment is a computer program for causing a computer of the information processing device that performs navigation processing of searching a route to the destination and presenting a guide route in accordance with a search result to function as the output control module that causes the voice output module to output the voice advertisement or the questionnaire related to a voice advertisement by voice based on the conversation with the user during navigation processing.

The information processing device according to the embodiment includes the utterance control module (control unit 21) that controls the characteristic of the utterance in the voice output from the voice output module (voice output unit 34) based on the traveling state of the vehicle C on which the user is riding during navigation processing.

Accordingly, with the information processing device according to the embodiment, the voice is output with an appropriate characteristic of the utterance depending on the traveling state of the vehicle C, so that an environment in the vehicle comfortable for the user can be made.

Regarding the information processing device according to the embodiment, the traveling state includes an environment outside the vehicle.

Accordingly, with the information processing device according to the embodiment, the voice is output with the characteristic of the utterance corresponding to the environment outside the vehicle, so that the environment in the vehicle more comfortable for the user can be made.

Regarding the information processing device according to the embodiment, the traveling state includes the state of the vehicle C.

Accordingly, with the information processing device according to the embodiment, the voice is output with the characteristic of the utterance corresponding to the environment outside the vehicle, so that the environment in the vehicle more comfortable for the user can be made.

Regarding the information processing device according to the embodiment, the traveling state includes the destination or the via-point.

Accordingly, with the information processing device according to the embodiment, the voice is output with the characteristic of the utterance corresponding to the destination or the via-point, so that the environment in the vehicle more comfortable for the user can be made.

Regarding the information processing device according to the embodiment, the traveling state includes the physical condition of the user.

Accordingly, with the information processing device according to the embodiment, the voice is output with the characteristic of the utterance corresponding to the physical condition of the user, so that the environment in the vehicle more comfortable for the user can be made.

With the information processing device according to the embodiment, the utterance control module determines the physical condition of the user based on the characteristic of the utterance in the response of the user acquired via the voice input module.

Accordingly, with the information processing device according to the embodiment, the physical condition of the user can be automatically acquired, so that an appropriate voice output can be performed by determining the physical condition of the user without giving a burden on the user.

Regarding the information processing device according to the embodiment, the traveling state includes the state of the fellow passenger.

Accordingly, with the information processing device according to the embodiment, the voice is output with the characteristic of the utterance corresponding to the state of the fellow passenger, so that the environment in the vehicle more comfortable for the user can be made.

With the information processing device according to the embodiment, the utterance control module determines the state of the fellow passenger based on the characteristic of the voice acquired via the voice input module.

Accordingly, with the information processing device according to the embodiment, the state of the fellow passenger can be automatically acquired, so that an appropriate voice output can be performed by determining the state of the fellow passenger without giving a burden on the user.

The information processing device according to the embodiment includes the voice changing module (control unit 21) that can change the voice output from the voice output module into a voice different from a standard voice. When the voice is changed into a different voice by the voice changing module and the fellow passenger is detected, the utterance control module changes the voice into the standard voice.

Accordingly, with the information processing device according to the embodiment, even when a voice output preferred by the user is performed, the voice can be automatically changed into the standard voice when the fellow passenger is detected, so that privacy of the user can be secured.

With the information processing device according to the embodiment, the utterance control module controls the form of the characteristic of the utterance based on the traveling state.

Accordingly, with the information processing device according to the embodiment, the voice is output with an appropriate form of the characteristic of the utterance depending on the traveling state of the vehicle C, so that a more comfortable environment in the vehicle adapted to the state can be made.

With the information processing device according to the embodiment, the utterance control module causes the question to be uttered by the voice output module, and controls content of the utterance based on the response of the user to the question acquired via the voice input module.

Accordingly, with the information processing device according to the embodiment, information about the user can be acquired through the conversation with the user, so that the utterance is performed with content of the utterance more appropriate for the user, and a more comfortable environment in the vehicle can be made.

With the information processing device according to the embodiment, the utterance control module controls the type of the utterance based on the traveling state.

Accordingly, with the information processing device according to the embodiment, the voice is output with an appropriate type of the utterance depending on the traveling state of the vehicle C, so that a more comfortable environment in the vehicle adapted to the state can be made.

Regarding the information processing device according to the embodiment, the type of the utterance includes at least the questionnaire, the voice advertisement, and other content.

Accordingly, with the information processing device according to the embodiment, an appropriate type of the utterance can be selected from a plurality of pieces of content depending on the traveling state of the vehicle C, so that an environment in the vehicle more comfortable for the user can be made.

With the information processing device according to the embodiment, the utterance control module causes the question to be uttered by the voice output module, and controls the type of the utterance based on the response of the user to the question acquired via the voice input module.

Accordingly, with the information processing device according to the embodiment, the information about the user can be acquired through the conversation with the user, so that utterance can be performed with the type of the utterance more appropriate for the user, and a more comfortable environment in the vehicle can be made.

With the information processing device according to the embodiment, the utterance control module controls at least one of the amount of utterance or the frequency of utterance based on the traveling state.

Accordingly, with the information processing device according to the embodiment, the voice is output with an appropriate amount of utterance and appropriate frequency of utterance depending on the traveling state of the vehicle C, so that a more comfortable environment in the vehicle adapted to the state can be made.

With the information processing device according to the embodiment, when the vehicle C is stopping, the utterance control module causes the display module (display unit 33) to display an image related to the utterance.

Accordingly, with the information processing device according to the embodiment, the image can be output in addition to the voice when the vehicle C is stopping, so that the user can easily understand the content of the utterance.

The information processing method performed by the information processing device according to the embodiment includes a step of controlling the characteristic of the utterance in the voice output from the voice output module based on the traveling state of the vehicle on which the user is riding during navigation processing.

The computer program stored in the non-transitory computer readable storage medium according to the embodiment is a computer program for causing a computer of the information processing device that performs navigation processing of searching a route to the destination and presenting a guide route in accordance with a search result to function as the utterance control module that controls the characteristic of the utterance in the voice output from the voice output module based on the traveling state of the vehicle on which the user is riding during navigation processing.

The information processing device according to the embodiment also includes the output control module (control unit 21) that performs at least one of a voice output or an image output again on the advertisement output from the output module (voice output unit 34) by voice during navigation processing when a predetermined condition is satisfied.

Accordingly, with the information processing device according to the embodiment, the advertisement output by voice can be re-output as needed, so that a plurality of advertisements output by voice can be impressed to be recognized.

Regarding the information processing device according to the embodiment, the case of satisfying the predetermined condition includes a case in which there is a predetermined positional relation with respect to the point related to the advertisement.

Accordingly, with the information processing device according to the embodiment, the advertisement is re-output when there is a positional relation in which the user tends to be interested, so that a plurality of advertisements can be recognized more appropriately.

Regarding the information processing device according to the embodiment, the case of satisfying the predetermined condition includes a case in which a predetermined keyword related to the advertisement uttered by the user is acquired via the voice input module within a predetermined range from the point related to the advertisement.

Accordingly, with the information processing device according to the embodiment, the advertisement is re-output when the user shows an interest in the advertisement, so that a plurality of advertisements can be recognized more appropriately.

Regarding the information processing device according to the embodiment, the case of satisfying the predetermined condition includes a case in which the vehicle is stopping, and the output control module causes the output module (display unit 33) to list and display the advertisements when the vehicle is stopping.

Accordingly, with the information processing device according to the embodiment, the advertisement is re-output in a state in which the user can visually recognize the advertisement, so that a plurality of advertisements can be compared with each other more safely.

Regarding the information processing device according to the embodiment, the case of satisfying the predetermined condition includes a case in which there is the second terminal device 30 associated with the first terminal device 30 including the output module that outputs the advertisement by voice in the vehicle C on which the user is riding. When there is the second terminal device 30, the output control module causes the output module of the second terminal device 30 to list and display the advertisements.

Accordingly, with the information processing device according to the embodiment, the advertisement is re-output in a state in which another user can visually recognize the advertisement, so that a plurality of advertisements can be compared with each other more safely.

The information processing device according to the embodiment also includes the module for evaluating superiority or inferiority (control unit 21) that evaluates superiority or inferiority of the advertisement based on the response of the user to the advertisement acquired via the voice input module. The output control module causes the output module to display the advertisement in superiority order based on superiority or inferiority evaluated by the module for evaluating superiority or inferiority.

Accordingly, with the information processing device according to the embodiment, an effect of the output advertisement can be acquired and reflected in display, so that a plurality of advertisements can be compared with each other more appropriately.

With the information processing device according to the embodiment, the output control module may cause the response of the user to the advertisement acquired via the voice input module to be reflected in at least one of the advertisement, the attribute of the advertisement, the user, or the attribute of the user, and causes the output module to output the advertisement by voice based on the reflection result.

Accordingly, with the information processing device according to the embodiment, the response to the output advertisement can be reflected in the advertisement or the user, so that a subsequent advertisement output can be performed more effectively.

With the information processing device according to the embodiment, the output control module causes the response of the user to the advertisement acquired via the voice input module to be reflected in the traveling state of the vehicle C on which the user is riding, and causes the output module to output the advertisement by voice based on the reflection result.

Accordingly, with the information processing device according to the embodiment, the response to the output advertisement can be reflected in the traveling state of the vehicle C, so that a subsequent advertisement output can be performed more effectively.

With the information processing device according to the embodiment, the output control module causes the response of the user to the advertisement acquired via the voice input module to be reflected in the characteristic of the utterance in the response of the user, and causes the output module to output the advertisement by voice based on the reflection result.

Accordingly, with the information processing device according to the embodiment, the response to the output advertisement can be reflected in the characteristic of the utterance in the response, so that a subsequent advertisement output can be performed more effectively.

The information processing method performed by the information processing device according to the embodiment includes a step of performing at least one of the voice output or the image output again on the advertisement output from the output module by voice during navigation processing when a predetermined condition is satisfied.

The computer program stored in the non-transitory computer readable storage medium according to the embodiment is a computer program for causing the computer of the information processing device that performs navigation processing of searching a route to the destination and presenting a guide route in accordance with a search result to function as the output control module that performs at least one of the voice output or the image output again on the advertisement output from the output module by voice during navigation processing when a predetermined condition is satisfied.

The embodiment of the present invention has been specifically described above. However, the present invention is not limited to the embodiment, and can be modified without departing from the gist of the invention.

4. Modification

For example, according to the above embodiment, the advertisement distribution server 20 distributes the content related to the voice advertisement in a form of conversation with the user via the terminal device 30. However, the embodiment is not limited thereto. For example, the control unit 21 of the advertisement distribution server 20 may distribute, to the terminal device 30, the information for conversation associating the utterance information for performing utterance based on the response of the user with the processing information for performing processing based on the response of the user acquired via the voice input unit 35 of the terminal device 30, and conversation may be made only between the terminal device 30 and the user.

In this case, the control unit 31 of the terminal device 30 performs voice recognition processing on the response of the user. The information for conversation distributed by the advertisement distribution server 20 includes the pattern data for collation to be utilized for voice recognition. The control unit 31 utilizes the pattern data for collation to perform voice recognition processing on the response of the user.

Specifically, the control unit 31 of the terminal device 30 acquires the information for conversation distributed from the advertisement distribution server 20. The control unit 31 then performs utterance via the voice output unit 34 based on the utterance information included in the acquired information for conversation. Next, the control unit 31 acquires the response of the user to the above question via the voice input unit 35, and performs voice recognition on the response of the user by referring to the pattern data for collation. Subsequently, the control unit 31 performs processing based on the response of the user based on a result of voice recognition and the processing information included in the information for conversation.

As described above, the output control module (control unit 21) distributes, to the terminal device 30 mounted on the vehicle C on which the user is riding, the information for conversation associating the utterance information for performing utterance based on the response of the user with the processing information for performing processing based on the response of the user acquired via the voice input module to eliminate the necessity of communication with the advertisement distribution server 20 in conversation with the user, so that service can be provided even when the vehicle enters a tunnel and the like and moves out of a communication range during the conversation.

Specifically, the information for conversation includes the pattern data for collation for performing voice recognition on the response of the user to eliminate the necessity of communication with the advertisement distribution server 20 in conversation with the user, so that service can be provided with higher quality while continuing the conversation with the user even when the vehicle enters a tunnel and the like and moves out of the communication range during the conversation.

As an example of the information for conversation, “information for uttering the questionnaire” as the utterance information is associated with “information for causing output processing of privilege (for example, giving a privilege point) information to be performed” as the processing information.

That is, the control unit 31 utters the questionnaire via the voice output unit 34 based on the acquired information for conversation. Next, the control unit 31 acquires a user's answer to the questionnaire via the voice input unit 35, and performs voice recognition on the user's answer. The control unit 31 then performs output processing of the privilege information based on the result of voice recognition and the processing information.

For example, when a condition for giving the privilege point is that there is an answer to the questionnaire irrespective of content of the user's answer, voice recognition is not required to be performed on the user's answer, so that the information for conversation does not necessarily include the pattern data for collation.

As described above, when the utterance includes the questionnaire, the response of the user includes the answer to the questionnaire, and the processing includes the output processing of the privilege information, a questionnaire answer can be obtained even when the navigation function is not utilized, so that the questionnaire answer can be expected to be habituated.

As another example of the information for conversation, “information for uttering the voice advertisement” as the utterance information is associated with “information for performing processing of causing information indicating the effect of the voice advertisement to be transmitted to the advertisement distribution server 20” as the processing information.

That is, the control unit 31 utters the voice advertisement via the voice output unit 34 based on the acquired information for conversation. The control unit 31 then acquires the information indicating the effect of the voice advertisement via the voice input unit 35, and performs voice recognition on the information indicating the effect of the voice advertisement. Subsequently, the control unit 31 performs processing of causing the information indicating the effect of the voice advertisement to be transmitted to the advertisement distribution server 20 based on the result of voice recognition and the processing information.

As described above, when the utterance includes the voice advertisement, the response of the user includes the information indicating the effect of the voice advertisement, and the processing includes the processing of causing the information indicating the effect of the voice advertisement to be transmitted to the information processing device (advertisement distribution server 20), the effect of the output voice advertisement can be acquired, which can be utilized for providing information to the advertiser or charging advertisement rates.

As another example of the information for conversation, “information for uttering the voice advertisement” as the utterance information is associated with “information for performing processing of causing information indicating the action based on the voice advertisement to be transmitted to the advertisement distribution server 20”.

That is, the control unit 31 utters the voice advertisement via the voice output unit 34 based on the acquired information for conversation. Next, the control unit 31 acquires the information indicating the action based on the voice advertisement, and analyzes the information indicating the action based on the voice advertisement. Subsequently, the control unit 31 performs processing for causing the information indicating the action based on the voice advertisement to be transmitted to the advertisement distribution server 20 based on an analysis result and the processing information.

As described above, when the response of the user includes the information indicating the action based on the voice advertisement, and the processing includes the processing for causing the information indicating the action to be transmitted to the information processing device, the effect of the output voice advertisement can be acquired, which can be utilized for providing information to the advertiser and charging advertisement rates.

As another example of the information for conversation, “information for uttering the question” as the utterance information is associated with “information for performing processing of determining to output one voice advertisement or any one of two or more voice advertisements, or not to output the voice advertisement, based on the answer to the question or no response”.

That is, the control unit 31 utters the question via the voice output unit 34 based on the acquired information for conversation. The control unit 31 then acquires the answer to the question or no response, and performs voice recognition. Subsequently, the control unit 31 performs processing of determining to output one voice advertisement or any one of two or more voice advertisements, or not to output the voice advertisement, based on the result of voice recognition and the processing information.

As described above, when the utterance includes the question related to a voice advertisement, the response of the user includes the answer to the question or no response, and the processing includes the processing of determining to output one voice advertisement or any one of two or more voice advertisements, or not to output the voice advertisement, based on the answer to the question or no response, the advertisement output can be controlled based on the response of the user, so that an effective advertisement output can be implemented without waste.

The above embodiment exemplifies the navi server 10 and the advertisement distribution server 20 as independent devices. However, the embodiment is not limited thereto. That is, the navi server 10 and the advertisement distribution server 20 may be configured as an integrated device.

If the terminal device 30 has both functions of the navi server 10 and the advertisement distribution server 20, the present embodiment can be implemented only with the terminal device 30.

Aspects described in the present application can also be grasped as a method, a computer program, and the like. In categories of a method or a computer program, “module” described in a category of a device is appropriately read as “process” or “step”, for example. Order of processing or steps is not limited to those clearly described herein. The order may be changed, part of the processing may be collectively performed, or each part of the processing may be separately performed as needed.

A detailed configuration and a detailed operation of the devices constituting the navi server, the advertisement distribution server, and the terminal device may also be appropriately modified without departing from the gist of the present embodiment.

According to the present invention, effect of the advertisement can be safely and smoothly secured without affecting driving.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device that performs navigation processing for searching a route to a destination and presenting a guide route in accordance with a search result, the information processing device comprising:
an output control module that causes a voice output module to output, by voice, a voice advertisement or a questionnaire related to a voice advertisement based on a conversation with a user during the navigation processing.

2. The information processing device according to claim 1, wherein
the output control module causes the voice output module to output, by voice, the voice advertisement when there is a predetermined positional relation with respect to a point related to the voice advertisement.

3. The information processing device according to claim 1, wherein
the output control module causes the voice output module to output, by voice, a question to the user for confirming a condition for causing the voice advertisement to be output by voice, and controls a voice output of the voice advertisement based on a response of the user to the question acquired via a voice input module.

4. The information processing device according to claim 3, wherein
the condition includes a condition related to a traveling state of a vehicle on which the user is riding.

5. The information processing device according to claim 1, further comprising:
an effect measuring module that measures an effect of the voice advertisement based on a response of the user to the voice advertisement acquired via a voice input module.

6. The information processing device according to claim 5, wherein
the effect measuring module acquires a user's evaluation for the voice advertisement and measures the effect of the voice advertisement based on a characteristic of an utterance in the response of the user to the voice advertisement.

7. The information processing device according to claim 1, wherein
the output control module distributes, to a terminal device mounted on a vehicle on which the user is riding, information for conversation associating utterance information for performing utterance based on the response of the user with processing information for performing processing based on the response of the user acquired via a voice input module.

8. The information processing device according to claim 7, wherein
the information for conversation includes pattern data for collation for performing voice recognition on the response of the user.

9. The information processing device according to claim 7, wherein
the utterance includes the questionnaire,
the response of the user includes an answer to the questionnaire, and
the processing by the output control module includes output processing of privilege information.

10. The information processing device according to claim 7, wherein
the utterance includes the voice advertisement,
the response of the user includes information indicating an effect of the voice advertisement, and
the processing by the output control module includes processing of causing the information indicating an effect of the voice advertisement to be transmitted to the information processing device.

11. The information processing device according to claim 10, wherein
the response of the user includes information indicating an action based on the voice advertisement, and
the processing by the output control module includes processing of causing the information indicating the action to be transmitted to the information processing device.

12. The information processing device according to claim 7, wherein
the utterance includes a question related to the voice advertisement,
the response of the user includes an answer to the question or no response, and
the processing by the output control module includes processing of determining to output one voice advertisement or any one of two or more voice advertisements, or not to output the voice advertisement, based on the answer to the question or no response.

13. The information processing device according to claim 1, further comprising:
an utterance control module that controls a characteristic of an utterance in a voice output from a voice output module based on a traveling state of a vehicle on which a user is riding during the navigation processing.

14. The information processing device according to claim 13, wherein
the traveling state includes an environment outside the vehicle.

15. The information processing device according to claim 13, wherein
the traveling state includes the state of the vehicle.

16. The information processing device according to claim 1, wherein
the output control module causes at least one of a voice output or an image output to be performed again on an advertisement output, by voice, from an output module during the navigation processing when a predetermined condition is satisfied.

17. The information processing device according to claim 16, wherein
a case of satisfying the predetermined condition includes a case in which there is a predetermined positional relation with respect to a point related to the advertisement.

18. The information processing device according to claim 16, wherein
a case of satisfying the predetermined condition includes a case in which a predetermined keyword related to the advertisement uttered by a user is acquired via a voice input module within a predetermined range from a point related to the advertisement.

19. An information processing method of an information processing device that performs navigation processing for searching a route to a destination and presenting a guide route in accordance with a search result, the information processing method comprising:
causing a voice output module to output, by voice, a voice advertisement or a questionnaire related to a voice advertisement based on a conversation with a user during the navigation processing.

20. A non-transitory computer readable storage medium having stored therein a program causing a computer of an information processing device that performs navigation processing for searching a route to a destination and presenting a guide route in accordance with a search result to function to execute a process comprising:
causing a voice output module to output, by voice, a voice advertisement or a questionnaire related to a voice advertisement based on a conversation with a user during the navigation processing.
